(19) United States
(12) Patent Application Publication
(10) Pub. No.: US 2006/0099857 A1
(43) Pub. Date: May 11, 2006

(54) EZ connect, 2 way splitter

(76) Inventor: Robert Scot Ames, Minden, NV (US)

Correspondence Address: Robert Ames, 1722 Westwiid Drive, Minden, NV, 89423, US

(21) Appl. No.: 11/113,297

(22) Filed: Jan. 12, 2006

Related U.S. Application Data
(60) Provisional application No. 60/582,640, filed on Jun. 25, 2004.

(51) Int. Cl. H01R 33/90

(52) U.S. Cl. 439/638

(57) ABSTRACT

The EZ-Connect 2-Way Splitter design is to improve the ascetic appearance of an installed coaxial cable on F-type wall plate, which will direct the coaxial cable parallel, which could be identified as down the wall, up the wall, or to the left or right when connected to the coaxial cable wall plate. The invention is designed in injected molded ABS plastic, the intended design being a right angle being a 2-way splitter, with a PCB circuitry design, where 2 female F-type connectors, miscellaneous resistors and caps, which meet cable video band or radio frequency (RF). With one F-type male push on connector, placed within an injected molded ABS case.

### FIELD OF THE INVENTION

The present invention is related the video accessories and components group, more specifically to video splitters.

### SUMMARY OF THE INVENTION

The present design is to improve the ascetic appearance of the coaxial cable from the wall plate and direct the cable parallel down, up, or to the left or right of the coaxial cable wall plate. The invention is designed as injected molded ABS right angle 2-way splitter, with a PCB circuitry design, where 2 female F-type connectors, misc. resistors and caps, which meet cable video band or radio frequency (RF) and one push on F plug, are soldered to and placed within a molded plastic case.

### BRIEF DESCRIPTION OF THE DRAWINGS

FIG. 1 is a fragmentary bottom front view of injection molded ABS housing 2-way splitter with threaded or snap in stand-offs, with the cut out for the placement of 2 F-type female connectors.

FIG. 2 is a fragmentary 2 dimensional top view of 2-way splitter injection molded ABS housing with threaded or snap in stand-offs, with cut out for placement of the 2 F-type female connectors.

FIG. 3 is a fragmentary top view of front section of 2-way splitter injection molded ABS housing with threaded or snap in stand-offs.

FIG. 4 is fragmentary side view of the front section of the 2-way splitter injection molded ABS housing with F-type female connectors.

FIG. 5 is a fragment top view of a injection molded ABS housing 2-way splitter with an F-type male push on connector, and cut out for 2 F-type female connectors.

FIG. 6 is a fragmentary 2 dimensional view of the rear injection molded ABS housing 2-way splitter, with push in snaps or open for set screw for (FIG. 1) front section molded plastic of 2-way splitter.

FIG. 7 is a fragment rear view of a injection molded ABS housing 2-way splitter with an F-type male push on connector, and cut out for 2 F-type female connectors.

FIG. 8 is fragmentary side view of back or rear of the 2-way splitter, which is of injection molded ABS housing, with side view of push on F-type male connector and side view of F-type female connectors.

FIG. 9 is a top view of completed assembled 2-way splitter, injection molded ABS housing with push on F-type male connector.

FIG. 10 is a rear view of completed assembled 2-way splitter with view of the push on F-type male connector and view of 2 F-type female connectors.

FIG. 11 is a bottom view of completed assembled 2-way splitter, with view 2-F-type female connectors and view of push on F-type male connector.

FIG. 12 is a front view of a completed assembles 2-way splitter with view of 2 F-type female connectors and view of threaded screws or snap in indentation on injection molded ABS housing.

### DETAILED DESCRIPTION

The following detailed description should be read with reference to the drawings, in which like elements in different drawings maybe numbered identically. The drawings which are not necessarily to scale, illustrate selected embodiments and are not intended to limit the scope of the invention. Several forms of the inventions have been shown and described, it will be understood that the embodiments shown in drawings and described below are merely for illustrative purposes, and are not intended to limit the scope of the invention as defined in the claims that follow.

FIG. 1 illustrates representation of fragmentation top front view of 2-way splitter with injection molded ABS housing 3 with threaded stand-off or snaps in stand-offs 1, with two (2) cut outs 2 for placement of two (2) female F-type connectors 4.

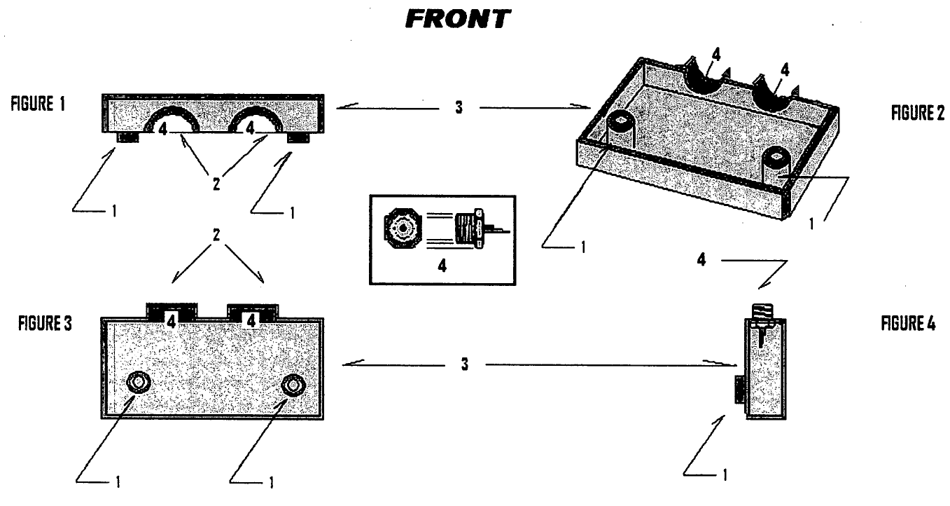

FIG. 2 illustrates fragmentary 2 dimensional view of 2-way splitter front injection molded ABS housing 3, with two cutouts 2 for placement of two F-type female connectors 4, and shows two threaded or snap in stand-offs.

FIG. 3 illustrates fragmentary full front view of 2-way splitter injection molded ABS housing 3, with two cutouts 2 for placement of two F-type female connectors 4, and front view of two threaded or snap in stand-offs 1.

FIG. 4 illustrates fragmentary side view of 2-way splitter injection molded ABS housing 3, with side view of threaded or snap in stand-offs 1, and side view of F-type female connector 4 on upper illustration.

FIG. 5 illustrates a fragmentary back bottom view of 2-way splitter injection molded ABS housing 7, with 2 cutouts 2 for two F-type female connectors 4, and view of F-type male push on connector 5.

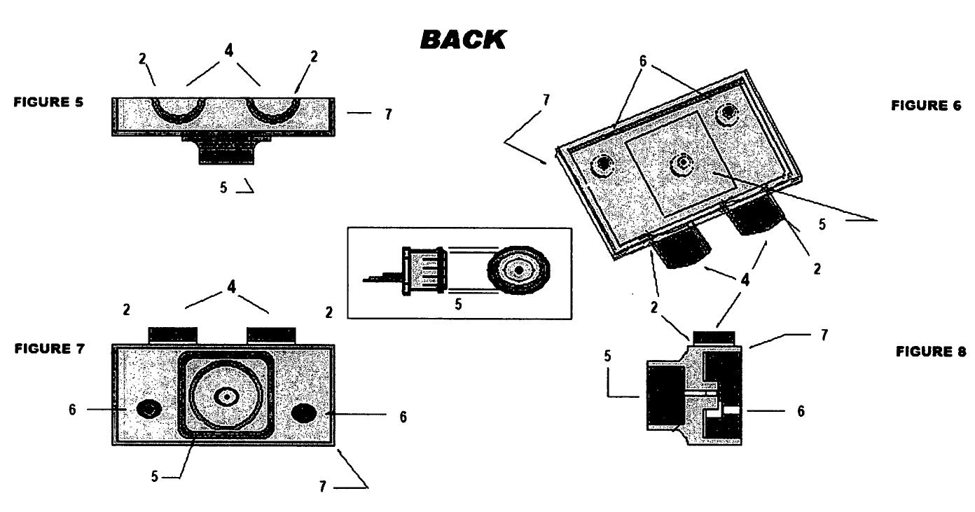

FIG. 6 illustrates a fragmentary 2 dimensional back view of 2-way splitter injection molded ABS housing 7, with view of 2 cutouts 2 for placement of two F-type female connectors 4, and indication location of center pin of F-type male push on connector 5.

FIG. 7 illustrates fragmentary view of complete back side of 2-way splitter injection molded ABS housing 7, with view of 2 cutouts 2 for placement of two F-type female connectors 4, also showing view of F-type male push on connector 5, and indentations for threaded screw holes or snap 6 for injection molded ABS standoffs 1.

FIG. 8 is fragmentary view of a side view of back or rear of the 2-way splitter injection molded ABS housing 7, with side view of push on F-type push on male connector 5, and side view of mounted F-type female connector 4, also showing indication of stand-off 6.

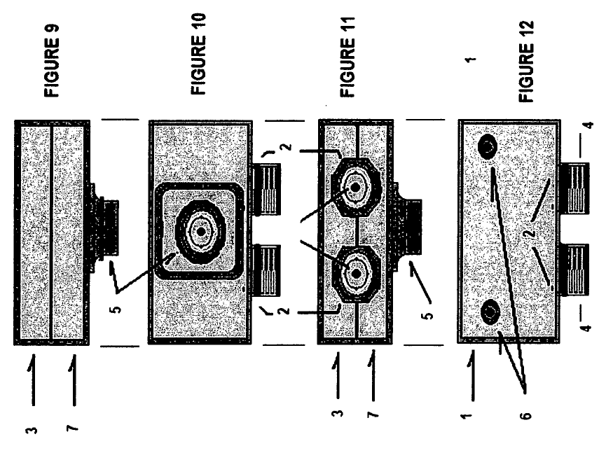

FIG. 9, FIG. 10, FIG. 11, AND FIG. 12 illustrates fully assembled 2-way splitter in injection molded ABS housing, showing full view of top, back, bottom and front of splitter, also illustrates full views of F-type female connectors, full view of F-type, and location of threaded screws or snap-in indentations. Previously submitted drawings with like elements for number and part (segment) identification should be referenced.

1. I claim that the EZ-Connect 2-Way Splitter design is to:
Improve the ascetic appearance of an installed coaxial cable on F-type wall plate.
Direct the coaxial cable parallel, which could be identified as down the wall, up the wall, or to the left or right when connected to the coaxial cable wall plate.
The invention is designed in injected molded ABS plastic.
Intended design being a right angle.
Being a 2-way splitter.
With a PCB circuitry design.
a. Where 2 female F-type connectors.
b. Misc. resistors and caps.
Which meet cable video band or radio frequency (RF).
With one F-type male push on connector.
Placed within a injected molded ABS case.
